(19) United States
(12) Patent Application Publication
(10) Pub. No.: US 2013/0081487 A1
(43) Pub. Date: Apr. 4, 2013

(54) CYLINDER

(71) Applicants: CHIN-TSAN HUANG, Tu-Cheng (TW); DONG-CHENG LIU, Shenzhen City (CN); XIAN-CAI ZENG, Shenzhen City (CN)

(72) Inventors: CHIN-TSAN HUANG, Tu-Cheng (TW); DONG-CHENG LIU, Shenzhen City (CN); XIAN-CAI ZENG, Shenzhen City (CN)

(73) Assignees: HON HAI PRECISION INDUSTRY CO., LTD., Tu-Cheng (TW); HONG FU JIN PRECISION INDUSTRY (ShenZhen) Co., LTD, Shenzhen City (CN)

(21) Appl. No.: 13/463,029

(22) Filed: May 3, 2012

(30) Foreign Application Priority Data
Sep. 29, 2011 (CN) 201110292352.5

(51) Int. Cl. F16H 25/12

(52) U.S. Cl. 74/57

(57) ABSTRACT

A cylinder includes a cylinder body, a piston assembly, and a guiding member. The cylinder defines a receiving hole. The guiding member is fixedly assembled within the receiving hole of the cylinder body, and is coaxial with the cylinder body. The guiding member defines a sliding groove and an arc rotating groove communicating with the sliding groove. The piston assembly includes a piston and at least one roll ball. The piston is assembled within the receiving hole of the cylinder body, and is slidably and rotatably sleeved on the guiding member via the at least one roll ball. The at least one roll ball is movably sandwiched between the piston and the guiding member, and is capable of sliding within the sliding groove and the rotating groove of the guiding member thereby driving the piston to slide and rotate relative to the guiding member.

### BACKGROUND

1. Technical Field

The present disclosure generally relates to cylinders, and particularly to a cylinder with rotating and linearly sliding functions.

2. Description of Related Art

Cylinders are widely used for conveying workpieces during industrial manufacturing process, or applying to position or drive other devices or mechanisms as a driver. A commonly used cylinder generally includes a cylinder body defining a receiving chamber, and a piston assembly slidably assembled within the receiving chamber of the cylinder body. One end of the piston assembly is exposed outside of the cylinder body for being connected to a pre-driven device or mechanism. Such that, the pre-driven device or mechanism is driven to move linearly relative to the cylinder body as in use. However, the existing cylinder is merely capable of fulfilling linear and retractable movements. In some automatic apparatuses, there often needs some cylinders having rotatable and retractable functions to fulfill rotatable and retractable movements.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure.

FIG. 1 shows an exploded, isometric view of an embodiment of a cylinder, the cylinder includes a cylinder body, a guiding member, a piston assembly, two guiding rods and a revolving arm.

FIG. 2 shows an exploded isometric view of some parts of the cylinder of FIG. 1.

FIG. 3 shows an assembled isometric view of some parts of the cylinder of FIG. 2.

FIG. 4 shows an isometric view of the cylinder in FIG. 1 in a using state.

FIG. 5 shows an isometric view of the cylinder in FIG. 1 in another using state.

FIG. 6 shows a cut-away view of FIG. 5.

### DETAILED DESCRIPTION

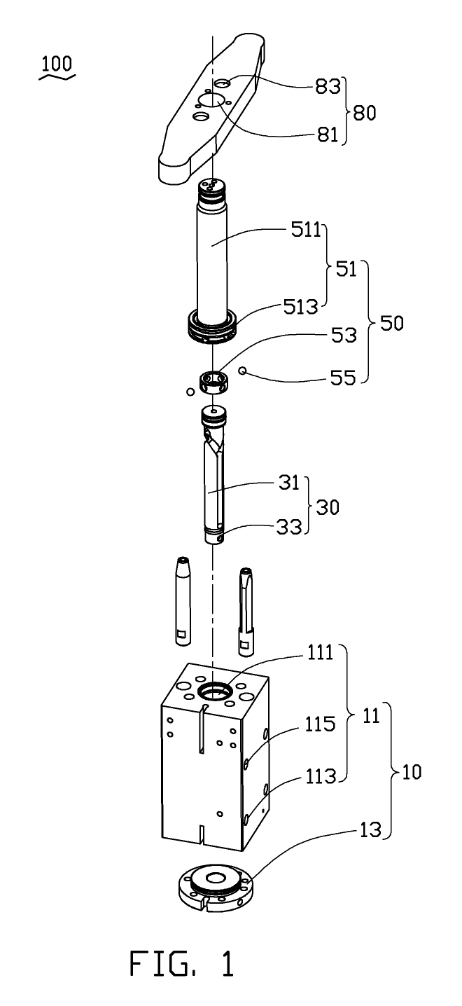

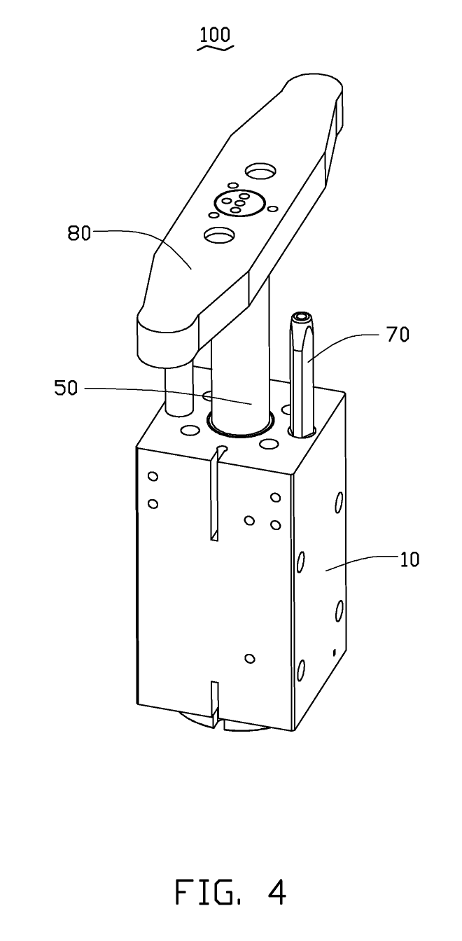

Referring to FIG. 1, an embodiment of a cylinder 100 is shown. The cylinder 100 includes a cylinder body 10, a guiding member 30, a piston assembly 50, two guiding rods 70 (labeled in FIG. 4), and a revolving arm 80. The guiding member 30 is fixedly assembled within the cylinder body 10. The piston assembly 50 is movably assembled within the cylinder body 10, and coaxially sleeved on the guiding member 30. One distal end of the piston assembly 50 is exposed outside of the cylinder 10. The two guiding rods 70 are oppositely mounted to a distal end of the cylinder body 10, and parallely positioned at two sides of the piston assembly 50. The revolving arm 80 is fixed to the distal end of the piston assembly 50 and sleeved on the two guiding rods 70.

The cylinder body 10 includes a cylinder barrel 11 and an end cover 13 detachably mounted to one end of the cylinder barrel 11. The cylinder barrel 11 defines a receiving hole 111 therethrough axially, for assembling the corresponding piston assembly 50. The end cover 13 covers one end of the receiving hole 111 of the cylinder barrel 11. An air input hole 113 and an air output hole 115 are defined through a peripheral wall of the cylinder barrel 11 to communicate with the receiving hole 111. The air input hole 113 and the air output hole 115 are respectively connected to two outer air sources (not shown), thereby providing air pressure for the cylinder body 10 via the air input hole 113, and exhausting the air in the cylinder body 10 via the air output hole 115.

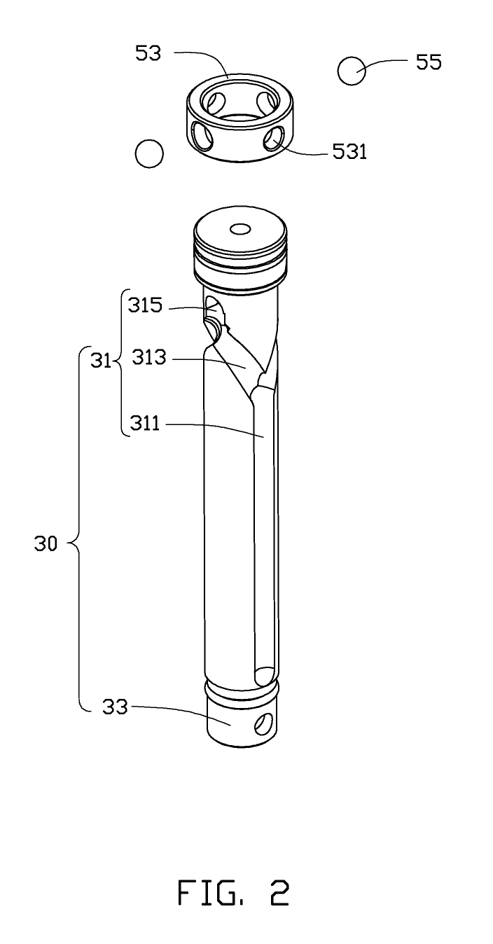

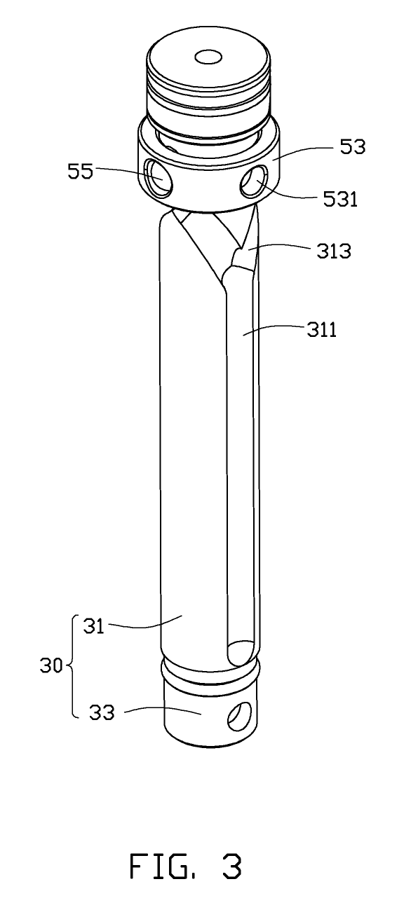

Also referring to FIGS. 2 and 3, the guiding member 30 is assembled within the receiving hole 111 of the cylinder body 10, with one end thereof fixed with the end cover 13. The guiding member 30 includes a substantially cylindrical guiding body 31 and a fixing portion 33 formed at a distal end of the guiding body 31. An outer peripheral wall of the guiding body 31 defines two axial sliding grooves 311, four arc rotating grooves 313, and two positioning grooves 315. The two axial sliding grooves 311 are symmetrically recessed from the outer peripheral wall of the guiding body 31, extending initially from a position adjacent to the fixing portion 33 end toward the opposite other end of the guiding body 31. The two positioning grooves 315 are symmetrically recessed from the outer peripheral wall of the guiding body 31 along a symmetric direction perpendicular to that of the two axial sliding grooves 311, and are positioned away from the fixing portion 33. The four rotating grooves 313 are recessed from the outer peripheral wall of the guiding body 31 and positioned between the two axial sliding grooves 311 and the two positioning grooves 315, thereby connecting the two axial sliding grooves 311 and the two positioning grooves 315 together. In the illustrated embodiment, the two axial sliding grooves 311 communicate with one corresponding positioning groove 315 via two of the four rotating grooves 313, and further communicate with the other positioning groove 315 via the leftover two rotating grooves 313. Namely, each axial sliding groove 311 communicates with two corresponding rotating grooves 313, each positioning groove 315 also communicates with two rotating grooves 313. It is to be noted here, in one embodiment, the outer peripheral wall of the guiding body 31 may merely define one axial sliding groove 311, one rotating groove 313, and one positioning groove 315 in that order from an end of the guiding body 31 adjacent to the fixing portion 33 toward another end of the guiding body 31 remote from the fixing portion 33, and the axial sliding groove 311, the rotating groove 313 and the positioning groove 315 are connected together in that order. In another embodiment, the positioning groove 315 can also be omitted.

The piston assembly 50 includes a piston 51, an assembling ring 53, and two roll balls 55. The piston 51 is coaxially sleeved on the guiding body 31 of the guiding member 30 via the assembling ring 53 and the two roll balls 55. The piston 51 is substantially hollow and cylindrical, and includes a base body 511 and an assembling flange 513 coaxially formed at one end of the base body 511. The assembling ring 53 is coaxially assembled within the assembling flange 513 of the piston 51 and sleeved on the corresponding guiding body 31 of the guiding member 30 via the two roll balls 55. The assembling ring 53 defines a plurality of mounting holes 531 along a circumferential direction thereof. The two roll balls 55 are oppositely assembled into two mounting holes 531 of the assembling ring 53 and partially engage into guiding body 31 of the guiding member 30. The two roll balls 55 are rotatably sandwiched between the assembling flange 513 of the piston 51 and the guiding body 31 of the guiding member 30, and are capable of sliding within the axial sliding grooves 311, the rotating grooves 313 and the positioning grooves 315, thereby guiding and driving the piston 51 to slide and rotate relative to the guiding member 30.

The two guiding rods 70 are both substantially cylindrical, and are oppositely mounted to the distal end of the cylinder body 10, away from the end cover 13, and are positioned parallel to an axial direction of the receiving hole 111 of the cylinder body 10.

The revolving arm 80 is fixed to a distal end of the piston assembly 50, and sleeved on the two guiding rods 70. The revolving arm 80 defines a fixing hole 81 through a substantially central portion thereof, corresponding to the piston 51, and two positioning holes 83 positioned at two sides of the fixing hole 81, oppositely, corresponding to the two guiding rods 70.

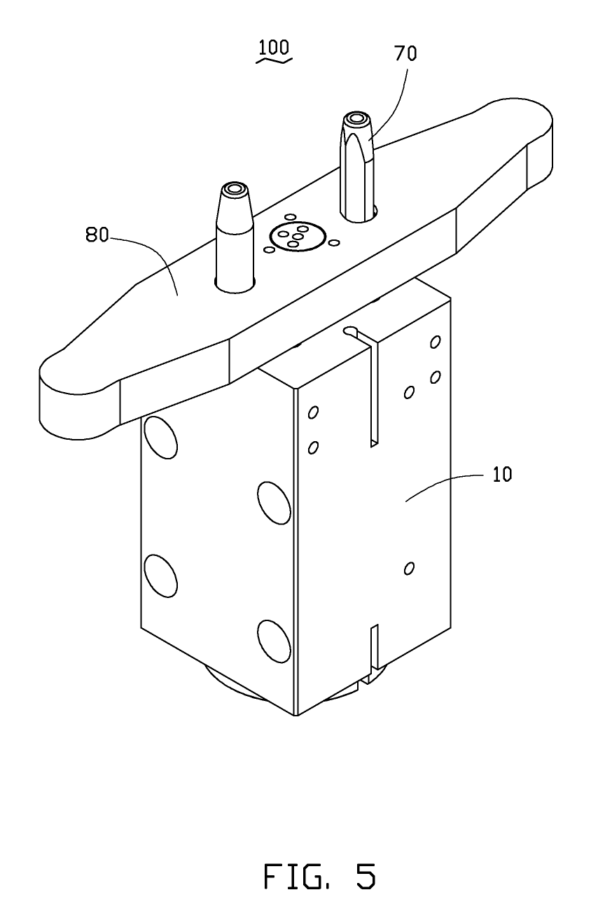

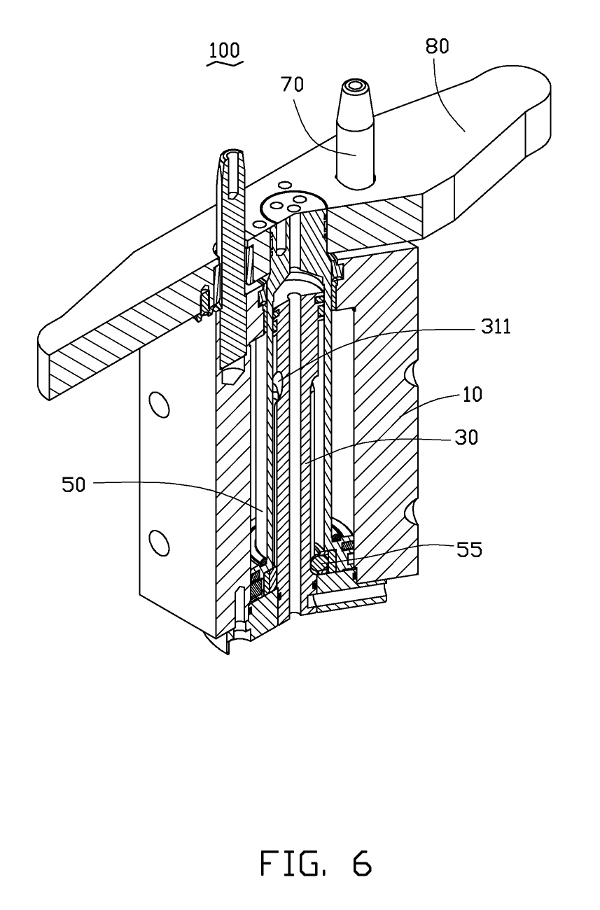

Also referring to FIGS. 4 through 6, when assembling the cylinder 100, the guiding member 30 is coaxially assembled within the receiving hole 111 of the cylinder body 10, the fixing portion 33 of the guiding member 30 is fixed to the end cover 13. The assembling ring 53 is coaxially assembled within the assembling flange 513 of the piston 51, and then, the two roll balls 55 are oppositely assembled into two mounting holes 531 of the assembling ring 53. The assembled piston assembly 50 is assembled into the receiving hole 111 of the cylinder body 10, and sleeved on the corresponding guiding body 31 of the guiding member 30. The roll balls 55 are partially engage into the guiding body 31 of the guiding member 30, and rotatably sandwiched between the assembling flange 513 of the piston 51 and the guiding body 31 of the guiding member 30. The two guiding rods 70 are mounted to the distal end of the cylinder body 10, away from the end cover 13, and positioned parallel to an axial direction of the receiving hole 111 of the cylinder body 10. The revolving arm 80 is fixed to the distal end of the piston assembly 50, and sleeved on the two guiding rods 70 to finish the assembly of the cylinder 100.

In use, the air input hole 113 and the air output hole 115 of the cylinder body 10 are respectively connected with two outer air sources (not shown) for driving the cylinder 100 to work. The piston 51 is firstly driven to slide axially relative to the cylinder body 10, meanwhile, the roll balls 55 rotatably engage with the axial sliding groove 311 and slide along the axial sliding groove 311 toward the guiding rod 70. The revolving arm 80 is driven to disengage with the guiding rods 70. When the roll balls 55 slide into the rotating grooves 313, the revolving arm 80 together with the piston 51 is driven to rotate about 90 degrees relative to the guiding member 30. The roll balls 55 are finally driven to slide into the positioning grooves 315, thereby stopping the piston 51, such that, the revolving arm 80 together with the piston 51 is positioned at a preset position.

During a backward stroke of the piston 51, the roll balls 55 are driven to slide out from the positioning grooves 315 of the guiding body 30, and then move into the rotating grooves 313 of the guiding body 30. Meanwhile, the revolving arm 80 together with the piston 51 is driven to rotate relative to the guiding member 30, reversely about 90 degrees. When the roll balls 55 is driven to slide into the axial sliding grooves 311 of the guiding member 31, the roll balls 55 are then driven to engage within the axial sliding groove 311 and slide along the axial sliding groove 311 backwardly, toward the end cover 13. The piston 51 together with the revolving arm 80 is driven to slide axially toward the end cover 13, the positioning holes 83 of the revolving arm 80 are align with the corresponding guiding rods 70, and the revolving arm 80 is finally sleeved on the guiding rods 70.

In one embodiment, the roll balls 55 and the assembling ring 53 may be omitted, and replaced by a bearing.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A cylinder, comprising:
a cylinder body defining a receiving hole;
a guiding member fixedly assembled within the receiving hole of the cylinder body, and being coaxial with the cylinder body; the guiding member defining a sliding groove and an arc rotating groove communicating with the sliding groove; and
a piston assembly comprising a piston and at least one roll ball, wherein, the piston is assembled within the receiving hole of the cylinder body, and is slidably and rotatably sleeved on the guiding member via the at least one roll ball; the at least one roll ball is movably sandwiched between the piston and the guiding member, and is capable of sliding within the sliding groove and the rotating groove of the guiding member thereby driving the piston to slide and rotate relative to the guiding member.

2. The cylinder of claim 1, wherein the cylinder body comprises a cylinder barrel and an end cover, the receiving hole is defined through the cylinder barrel axially, the end cover is detachably mounted to one end of the cylinder barrel for covering one end of the receiving hole; the guiding member comprises a substantially cylindrical guiding body and a fixing portion formed on a distal end of the guiding body, the guiding body is coaxially received within the receiving hole of the cylinder body, the fixing portion is fixed to the end cover.

3. The cylinder of claim 2, wherein the cylinder barrel defines an air input hole and an air output hole through a peripheral wall thereof to communicate with the receiving hole.

4. The cylinder of claim 2, wherein the sliding groove is axially recessed from the outer peripheral wall of the guiding body, extending from an end of the guiding body adjacent to the fixing portion toward an opposite end of the guiding body remote from the fixing portion; the rotating groove is circumferentially recessed the outer peripheral wall of the guiding body to communicate with the sliding groove.

5. The cylinder of claim 4, wherein the guiding member further defines a positioning groove communicating with a distal end of the rotating groove away from the sliding groove, the positioning groove is positioned away from the fixing portion.

6. The cylinder of claim 5, wherein the piston is substantially hollow cylindrical, and comprises a base body and an assembling flange coaxially formed at one end of the base body; the piston assembly further comprises an assembling ring coaxially assembled within the assembling flange of the piston and sleeved on the guiding body of the guiding member via the at least one roll ball.

7. The cylinder of claim 6, further comprising a revolving arm, wherein the revolving arm is fixed to a distal end of the base body of the piston, away from the assembling flange and exposed outside of the cylinder body.

8. The cylinder of claim 7, wherein the revolving arm defines two positioning holes positioned at two sides of the piston, the cylinder further comprises two guiding rods oppositely mounted to the distal end of the cylinder body, and respectively align with corresponding two positioning holes of the revolving arm.

9. A cylinder, comprising:
a cylinder body defining a receiving hole;
a guiding member fixedly assembled within the receiving hole of the cylinder body, and being coaxial with the cylinder body; the guiding member defining two sliding grooves and four circumferential rotating grooves communicating with the two sliding grooves; wherein, the two sliding grooves are symmetrically and axially recessed from the outer peripheral wall of the guiding member, the four rotating grooves are circumferentially recessed from the outer peripheral wall of the guiding member and communicate with the two sliding grooves; and
a piston assembly comprising a piston and two roll balls, wherein, the piston is assembled within the receiving hole of the cylinder body, and is slidably and rotatably sleeved on the guiding member via the two roll balls; the two roll balls are movably sandwiched between the piston and the guiding member, and is capable of sliding within the sliding grooves and the rotating grooves of the guiding member thereby driving the piston to slide and rotate relative to the guiding member.

10. The cylinder of claim 9, wherein the cylinder body comprises a cylinder barrel and an end cover, the receiving hole is defined through the cylinder barrel axially, the end cover is detachably mounted to one end of the cylinder barrel for covering one end of the receiving hole; the guiding member comprises a substantially cylindrical guiding body and a fixing portion formed on a distal end of the guiding body, the guiding body is coaxially received within the receiving hole of the cylinder body, the fixing portion is fixed to the end cover.

11. The cylinder of claim 10, wherein the cylinder barrel defines an air input hole and an air output hole through a peripheral wall thereof to communicate with the receiving hole.

12. The cylinder of claim 10, wherein the guiding member further defines two positioning grooves symmetrically recessed from the outer peripheral wall of the guiding body along a symmetric direction perpendicular to that of the two sliding grooves, and positioned away from the fixing portion end; the two positioning grooves communicate with the rotating grooves.

13. The cylinder of claim 12, wherein the piston is substantially hollow cylindrical, and comprises a base body and an assembling flange coaxially formed at one end of the base body; the piston assembly further comprises an assembling ring coaxially assembled within the assembling flange of the piston and sleeved on the guiding body of the guiding member via the roll ball.

14. The cylinder of claim 13, further comprising a revolving arm and two guiding rods, wherein the revolving arm is fixed to a distal end of the base body of the piston, away from the assembling flange and exposed outside of the cylinder body; the revolving arm defines two positioning holes positioned at two sides of the piston, the two guiding rods are oppositely mounted to a distal end of the cylinder body, and respectively align with corresponding two positioning holes of the revolving arm.
